(19) United States
(12) Patent Application Publication
(10) Pub. No.: US 2002/0134890 A1
(43) Pub. Date: Sep. 26, 2002

(54) Parachute with a controlled active lift

(76) Inventor: Leonid Berzin, Brooklyn, NY (US)

Correspondence Address: BORIS LESCHINSKY, 30 WEST SADDLE RIVER ROAD, WALDWICK, NJ, 07463, US

(21) Appl. No.: 09/816,439

(22) Filed: Mar. 26, 2001

(51) Int. Cl. B64D 17/00; B64D 19/00; B64D 21/00; B64D 23/00

(52) U.S. Cl. 244/142

(57) ABSTRACT

A parachute having two air-balloon sections within the upper portion of the main canopy. Each of these air-balloon sections is isolated from the main canopy and from the other air-balloon section. Both air-balloon sections are filled with lighter-than-air gas, for example helium, and thus provide an active lift to the parachute. At least one inflating air valve and deflating air valve are provided at each air-balloon section for inflating and deflating them. The sections are filled either manually, in accordance with a predetermined scheme, by the parachutist himself or automatically after the main canopy opens up. Gas is preferably contained within two gas tanks, one for each section, located on the back of the parachutist on both sides of the backpack, containing the parachute and attached to the harness worn by the user. The provided parachute may be used as safety equipment, a sport or recreational device, and/or as a mode of transportation allowing a prolonged floating in the air.

### BACKGROUND OF THE INVENTION

The present invention relates to parachutes providing an active lift allowing its user to prolong the flight and to accomplish a safe landing. More specifically, the present invention relates to a parachute having, in addition to a main canopy, at least one isolated air-balloon sections, which may be filled with high pressure gas, for example helium, after the main canopy opens up. Such helium-filled air-balloon section will provide an active controlled lift to the open chute.

Parachutes are typically umbrella-like devices for slowing the descent of a body falling through the atmosphere. Parachutes and balloons were invented at virtually the same time, although independently of one another. There are many known air-flowing devices utilizing different types of gas (typically compressed, hot or heated air and/or helium). Such devices are usually constructed as either an air balloon or a combination of an air-balloon with a parachute. Apparatuses combining features of both devices typically constructed as air-balloons capable of being transformed into a parachute when the balloon deflates, thus providing a safe lending. One such apparatus is disclosed in U.S. Pat. No. 496,854 (incorporated herein by reference), issued to Capazza in 1893. The air-balloon disclosed in the '854 patent is transferable into a parachute when the balloon loses the gas it is filled with. The resulting parachuting device provides a safe landing for the balloon car and its passengers. Likewise, an apparatus, disclosed in U.S. Pat. No. 3,154,268 (incorporated herein by reference), issued to Struble in 1964, discloses a balloon and parachute combination, which can also be quickly transformed into a parachute. Another possible combination is disclosed in U.S. Pat. No.512,450 (incorporated herein by reference), issued to Schneider-Preiswerk in 1894, describing an attached to a balloon umbrella-like chute, which reacts to a change in direction of the air-flow.

U.S. Pat. No. 3,508,725 (incorporated herein by reference), issued to Nebiker in 1970, discloses a pilot airborne recovery device. The disclosed recovery device is a parachute that has in its upper part a folded balloon. After the pilot ejects from an airplane and the parachute opens up, the folded balloon may be opened and filed with hot air, heated by a burner underneath the balloon. The pilot may then float in the air until a recovery airplane picks him up.

U.S. Pat. No. 3,679,155 (incorporated herein by reference), issued to Centofanti in 1972, discloses a parachute with an enclosed balloon, which when filled with gas transforms into an air-balloon. Design of such apparatus, however does not allow its user to control his/her descent. Additionally, the parachute of the '155 patent does not have any inflating valves and its gas container is located within the parachute system itself.

U.S. Pat. No. 1,929,005 (incorporated herein by reference), issued to Rocker in 1933, discloses a parachute which may be opened by using compressed air. Compressed air is used only to facilitate opening of the parachute and only during descent. The main object of this design is to save an airplane and its crew. Similarly, U.S. Pat. No. 3,372,893 (incorporated herein by reference), issued to Larsen et. al in 1968, discloses use of compressed air to fill a model of an airplane during descent.

Thus, there is a considerable interest in the art for a parachute which will provide a controlled active lift, allow its user to prolong the floating time and accomplish safe landing of the user.

### SUMMARY OF THE INVENTION

It is an object of the present invention to provide a parachute with an active lift that can be controlled by the parachutist.

It is another object of the present invention to provide a parachute that will allow the parachutist to control the speed of its descent and its travel distance.

It is a further object of the present invention to provide a parachute that may be converted into a water-floating device.

Further objects and/or advantages of the invention will become apparent in conjunction with the disclosure herein.

To accomplish the above objects, the present invention provides a parachute having at least one but preferably two air-balloon sections within the upper portion of the main canopy. Each of these air-balloon sections is isolated from the main canopy and from the other air-balloon section. Both air-balloon sections may be filled with lighter-than-air gas, for example helium, and thus provide an active lift to the parachute. At least one inflating air valve and deflating air valve are provided at each air-balloon section for inflating and deflating them. The sections are filled either manually in accordance with a predetermined scheme by the parachutist himself or automatically after the main canopy opens up. Gas is preferably contained within two tanks, one for each section, located on the back of the parachutist on both sides of the backpack, containing the parachute and attached to the harness worn by the user. The provided parachute may be used as safety equipment, a sport or recreational device, and/or as a mode of transportation allowing a prolonged floating in the air.

### BRIEF DESCRIPTION OF THE DRAWINGS

A full understanding of the invention can be gained from the following description of the preferred embodiments when read in conjunction with the accompanying drawings in which:

FIG. 1 is a perspective view of the parachute with a controlled active lift, in accordance with the preferred embodiment of the present invention; and

FIG. 2 is a cross-sectional view of the travelers' the parachute with a controlled active lift of FIG. 1 taken along line A-A.

### DETAILED DESCRIPTION OF THE PREFERRED EMBODIMENTS AND THE DRAWINGS

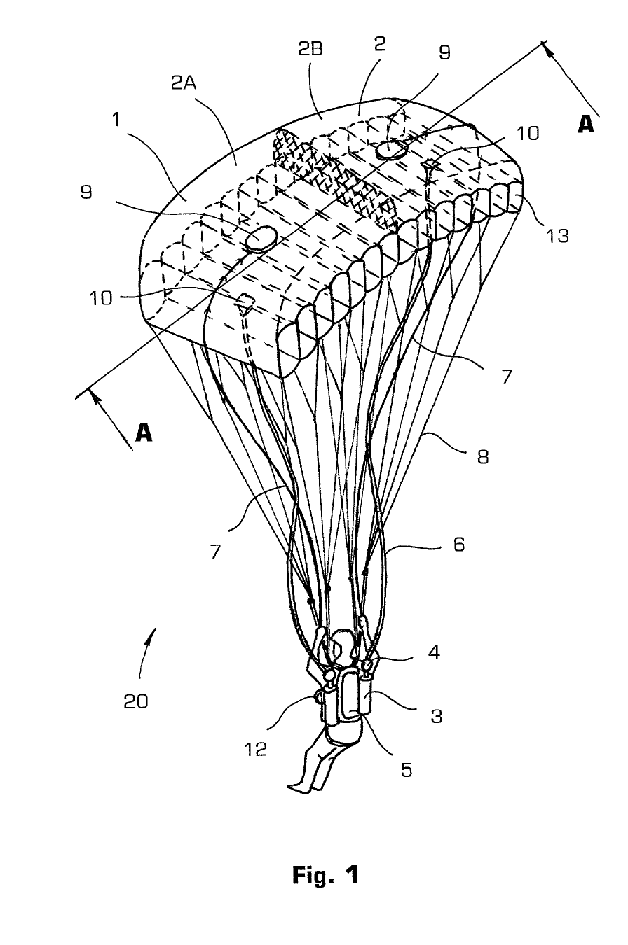

The preferred embodiment of the present invention is shown in FIG. 1. The provided parachute, generally designated with a reference number 20, preferably comprises a main canopy 1 having an upper portion 2 and a lower portion 13. The parachute 20 is preferably a gliding wing-type parachute that may take advantage of the glide potential through manipulation of the suspension lines 8. Gliding is further facilitated by the plurality of aerodynamic channels 11 within the lower portion 13.

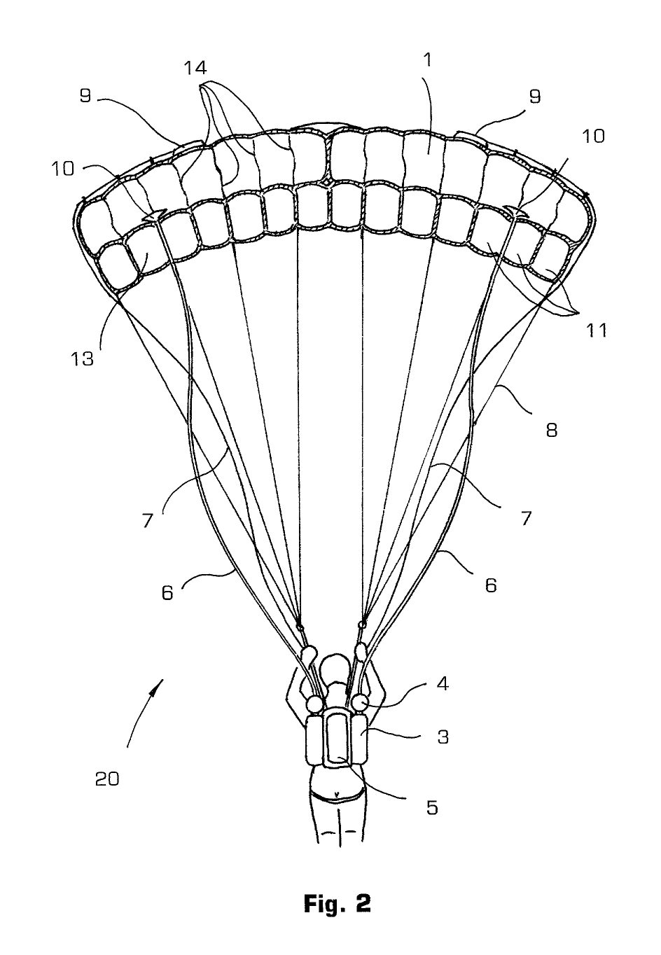

In accordance with the preferred embodiment, the upper portion 2 of the parachute 20 comprises two air-balloon sections 2A and 2B. In another embodiment, one air-balloon section may be used in connection with the present invention. The air-balloon sections 2A and 2B are preferably isolated from each other and from the lower portion 13 of the main canopy 1. To prevent deflation of the air-balloon sections, they are preferably made of a gas impermeable material, for example nylon. To maintain its desired shape, each section 2A and 2B may be optionally equipped with vertical elastic cords 14 (shown only on FIG. 2 for clarity) connecting its upper and lower part at a fixed distance. Such cords may be made of rubber or another appropriate elastic material. Each air-balloon section is preferably equipped with at least one inflating air valve 10 and at least one deflating air valve 9. As more particularly shown in FIG. 2, each inflating air valve 10 is connected to a gas tank 3 through a high-pressure air-hose 6. Each gas tank 3 is preferably filled with lighter-than-air pressurized gas, for example helium, hydrogen or methane. In the preferred embodiment, gas tanks 3 are filled with pressurized helium. Each high-pressure air-hose 6 is preferably connected to a valve 4 of one of the gas tanks 3. Valves 4 may be opened manually by handle 12 or may be programmed to open automatically within a predetermined time interval after the lower portion of the main canopy 1 has been opened. When valves 4 are opened, pressurized gas fills air-balloon sections through high-pressure air-hoses 6 and inflating valves 10. Optionally, valves 4 may substitute valves 9 and 10 entirely if they are designed to act as pressure regulators. Filled air-balloon sections will provide buoyancy to the parachute 20 so that it will rise and float in the atmosphere. Thus, an additional lift force is generated which allows a parachute-carrier or parachutist to float in the atmosphere for a prolonged period of time.

While gliding of the parachute may be controlled by suspension lines 8 and aerodynamic channels 11, its descent may be controlled by a deflating valve 9 through a control cord 7. To increase the descending speed, the parachutist may open deflating valves 9, using the control cord 7, and decrease gas volume and pressure within air-balloon sections 2A and 2B. Consequently, the speed of the descent will increase.

Gas tanks 3 are preferably located on the parachutist's back adjacent to the backpack 5 attached to the harness (not shown) worn by the parachutist. In the preferred embodiment of the invention, one gas tank is located to the left of the backpack and the other gas tank is located to the right of the backpack. Gas tanks 3 may be selectively separated from the backpack 5 to increase the lift force and to prolong the time of flight.

The above-described design of the parachute canopy 1 allows the canopy to be converted into a safety raft when the parachutist lends on water. Air-balloon sections filled with gas will provide adequate buoyancy to allow the canopy to float on water. In this embodiment, the canopy is preferably made of a waterproof material. Navy or air force parachutists and/or any other users who are forced to land on water in an emergency situation may use a parachute constructed in accordance with this embodiment.

In use, the parachute with a controlled active lift, in accordance with the present invention, is opened in traditional manner when a user jumps from an airplane. opening of the parachute may be accomplished manually, automatically or through a cord connected to the airplane. In the preferred embodiment, only the lower portion 13 of the canopy 1 will open initially. When the parachute is stabilized in the air, the parachutist may open valves 4 of gas tanks 3 using the control handle 12. Alternatively, valves 4 may be programmed to open automatically within a predetermined time interval after opening of the lower portion 13 of the canopy 1. Gas tanks 3 are preferably filled with helium or any other lighter-than-air gas, which flows through open valves 4, high pressure air-hoses 6, inflating valves 10 and into air-balloon sections 2A and 2B. After air-balloon sections are filled with gas, the parachute 20 will acquire necessary buoyancy to decrease its descent, rise or float in the atmosphere. Gliding of the parachute 20 along a desired trajectory in the atmosphere is achieved through the aerodynamic channels 11. By pulling on the appropriate suspension line 8, the parachutist can spill air out of aerodynamic channels 11 on one side of the parachute or the other, and increase or decrease the lift of the wing, thus turning, diving, or even hovering under favorable conditions. Any other known trajectory-controlling design element may be used with the present invention. To change the altitude of the parachute 20, the parachutist may open deflating valves 9 using the control cord 7, thereby deflating the air-balloon sections 2A and 2B. Consequently, the parachute will descend toward the ground. The volume of gas within the air-balloon sections and the descending speed of the parachute are in reverse relationship, the greater the volume the slower the descent. Therefore, the parachutist can control the speed of his/her descent by regulating the gas volume in the air-balloon sections through the set of inflating and deflating valves. In fact, the gas volume may be manipulated to achieve a zero or near zero-speed of descent. Such zero-speed may be particular useful at the moment of landing. The parachutist's and/or cargo's landing will be much safer at such zero or near zero-speed.

The parachute with a controlled active lift, disclosed herein, may be used with modern military jet aircraft which are typically provided with ejection seats that shoot occupants free of their craft and automatically release a parachute when they are at a safe altitude. The presently disclosed parachute may also be used by the military for airborne operations and emergency re-supply. Parachutes constructed in accordance with this disclosure may be used as braking devices for rockets, space vehicles, airplanes, and high-speed surface vehicles. Because a user may control the speed of descent and because the parachute may land on water surfaces, the present invention provides a very safe way for training new and inexperienced parachutists. Additionally, a set of pressure sensors sending a signal to a remote receiver, located for example on the ground, may be installed inside each air-balloon section and valves 4 of gas tanks 3 may also be controlled remotely, that will allow another user to regulate the speed of descent (and, therefore, to control the flight) from a remote location. Of course, the parachutist himself may be equipped with a remote control for remotely controlling the speed of descent.

Having described this invention with regard to specific embodiments, it is to be understood that these embodiments are merely illustrative of the principles and applications of the present invention. It is therefore to be understood that numerous modifications may be made to the illustrative embodiments. For example, the invention may be used together with an umbrella-type parachute, a ring-type parachute or any other parachute known in the art. Air heaters or burners may also be used instead of tanks with compressed gas as a source of lighter-then-air gas. These and other arrangements may be devised without departing from the spirit and scope of the present invention as defined by the appended claims.

What is claimed is:

1. A parachute with a controlled active lift, comprising:
a main canopy, said main canopy further comprising a first portion and a second portion, said first and said second portions being adjacent to each other;
said first portion having at least one air-balloon section, said air-balloon section having a deflating means and an inflating means;
at least one gas tank attached to said parachute, said gas tank being filled with gas;
a connecting means, said connecting means connecting said gas tank to said inflating means of said air-balloon section; and
a control means, said control means controlling opening and closing of said gas tank and said deflating means of said air-balloon section; wherein when said gas tank is opened by said control means, said gas is passed through said connecting means and through said inflating means into said air-balloon section; wherein when said air-balloon section is filled with said gas, said parachute's descending speed is decreased; wherein when said control means open said deflating means, said gas exists from said air-balloon section; and wherein when said air-balloon section is deflated, said parachute's descending speed is increased.

2. A parachute with a controlled active lift according to claim 1, wherein said first portion of said main canopy comprises at least two said air-balloon sections.

3. A parachute with a controlled active lift according to claim 1, wherein said first portion of said main canopy is further equipped with vertical elastic cords to maintain its desired shape.

4. A parachute with a controlled active lift according to claim 1, wherein said second portion of said parachute is configured to open up when a parachute-carrier drops from an airplane.

5. A parachute with a controlled active lift according to claim 1, wherein said second portion further comprises a plurality of aerodynamic channels.

6. A parachute with a controlled active lift according to claim 1, wherein said first portion of said main canopy is located on top of said second portion of said main canopy.

7. A parachute with a controlled active lift according to claim 1 further comprising a backpack for containing said parachute, wherein said gas tank is attached to said backpack.

8. A parachute with a controlled active lift according to claim 1, wherein said gas tank is filled with lighter-than-air gas.

9. A parachute with a controlled active lift according to claim 1, wherein said controlling means open said gas tank automatically within a predetermined time interval after said second portion of said main canopy has been opened.

10. A parachute with a controlled active lift according to claim 1, wherein said control means comprises a handle for opening said gas tank.

11. A parachute with a controlled active lift according to claim 1, wherein said control means comprises a control cord for opening said deflating means.

12. A parachute with a controlled active lift according to claim 1, wherein said deflating means comprises a deflating valve.

13. A parachute with a controlled active lift according to claim 1, wherein said inflating means comprises an inflating valve.

14. A parachute with a controlled active lift according to claim 1, herein said main canopy is made of a waterproof material.

15. A parachute with a controlled active lift according to claim 1, wherein said main canopy is made of nylon.

16. A parachute with a controlled active lift according to claim 1, wherein said air-balloon section further comprises at least one pressure sensor, said pressure sensor being configured to send signals to a remote receiver.

17. A parachute with a controlled active lift, comprising:
a main canopy;
at least one air-balloon section contained in said main canopy, said air-balloon section having a deflating means and an inflating means, said inflating means including a source means of lighter-than-air gas; and
a control means for controlling said inflating means and said deflating means; whereby said active lift is adjusted by said control means allowing said gas into or out of said air-balloon portion.
